(19) United States
(12) Patent Application Publication
(10) Pub. No.: US 2026/0087104 A1
(43) Pub. Date: Mar. 26, 2026

(54) DATA PRIVACY PROTECTION AND REMOVAL FOR ARTIFICIAL INTELLIGENCE MODEL TRAINING AND DEPLOYMENT

(71) Applicant: PAYPAL, INC., San Jose, CA (US)

(72) Inventors: Vishal Kumar Singh, Howrah (IN); Ashraf Kamal, New Delhi (IN); Padmapriya Mohankumar, Chennai (IN)

(21) Appl. No.: 18/896,700

(22) Filed: Sep. 25, 2024

(51) Int. Cl. G06F 21/10; G06N 3/082; G06Q 50/18

(52) U.S. Cl. CPC G06F 21/106; G06N 3/082; G06Q 50/184

(57) ABSTRACT

There are provided systems and methods for data privacy protection and removal for artificial intelligence model training and deployment. An online transaction processor or other service provider may provide computing services and platforms to entities, which may include use of machine learning (ML) models including large language models (LLMs). To comply with data privacy protections and copyright enforcement, a system may provide unlearning of content from ML models. The system may receive a request to unlearn a content and, after verifying the request is valid, identify the content used for during training of or inferencing by an ML model. The system may then map the content to concepts and correlate those concepts with ML model outputs using projections in a vector space. Based on the mapped concepts and outputs, neuron activation of the ML model may be analyzed to identify a negation vector and perform selective parameter dampening.

### TECHNICAL FIELD

The present disclosure relates generally to artificial intelligence (AI) and machine learning (ML) systems and models, and more specifically to configuring large language models (LLMs) to remove privacy protected data used during model training.

### BACKGROUND

LLMs are widely used in enterprise applications due to their generalized natural language processing (NLP) capabilities. For example, service providers may have large computing systems and services that use LLMs and provide applications, websites, resources, and other computing services, including automated chatbots and other automated processes, with different end users, such as customers, clients, internal users and teams, and the like. Users may interact with various computing services that provide intelligent and automated responses and interactions based on the LLMs, neural networks (NNs), and other ML models.

However, the proliferation of ML models and LLMs across various domains has led to an increasing concern regarding the presence of copyrighted information, sensitive data, proprietary concepts, and secure credentials that may be used to train the models and/or are relied on during inferencing, such as when providing responses to users and/or outputting predictions. As such, ML models, such as LLMs and NNs, may utilize and/or incidentally reveal privacy protected data during interfacing and interactions with users when those models are trained on such data. Further, as hackers and other malicious users or entities become more sophisticated, they may perform different computing attacks and other malicious conduct. For example, fraudsters may attempt to compromise sensitive data to access and/or utilize such data for fraudulent purposes from ML models, such as LLM chatbots, which cause ML models to release, rely on and use, or respond with copyright and/or privacy protected data. Despite rigorous data pre-processing and model training, ML models may inadvertently learn and retain such information, which causes legal, ethical, and security risks. As such, it is desirable to provide a system and operations for ML models to efficiently and accurately unlearn and/or remove content and other data that may have been used during training and/or is utilized during inferencing and responding to requests, while maintaining model accuracy and effectiveness for automated decisioning. Thus, there exists a need for a systematic and automated approach to identify, evaluate, and unlearn the presence of copyrighted content, sensitive data, proprietary concepts, and credentials in ML models without retraining to ensure compliance with legal regulations, protect intellectual property, safeguard sensitive information, and maintain ethical standards.

### BRIEF DESCRIPTION OF THE DRAWINGS

FIG. 1 is a block diagram of a networked system suitable for implementing the processes described herein, according to an embodiment;

FIGS. 2A-2C are exemplary computing architectures of a service provider that performs selective parameter dampening to unlearn and/or remove content learned by ML models, according to an embodiment;

FIGS. 3A-3E are exemplary diagrams of concept mapping and node identification for selective parameter dampening, according to various embodiments;

FIG. 4 is a flowchart for data privacy protection and removal for AI model training and deployment, according to an embodiment; and

FIG. 5 is a block diagram of a computer system suitable for implementing one or more components in FIG. 1, according to an embodiment.

Embodiments of the present disclosure and their advantages are best understood by referring to the detailed description that follows. It should be appreciated that like reference numerals are used to identify like elements illustrated in one or more of the figures, wherein showings therein are for purposes of illustrating embodiments of the present disclosure and not for purposes of limiting the same.

### DETAILED DESCRIPTION

Provided are methods for data privacy protection and removal for AI model training and deployment. Systems suitable for practicing methods of the present disclosure are also provided.

A service provider, such as an online transaction processor, may provide computing services to users and/or their corresponding entities, which may include end users and customers, merchant customers of an online transaction processor, businesses and their representatives and/or employees, and the like. These computing services may include those associated with electronic transaction processing, payments, digital account usage, peer-to-peer transfers and payments, and the like. With these computing services, automated help or assistance may be provided through chatbots in an email channel, a digital alert channel, a text message channel, a push notification channel, an instant message channel, or the like. These chatbots and other automated computing processes may allow end users of a service provider to engage in self-service assistance options associated with one or more services of the service provider. For example, an online transaction processor may provide automated assistance options for account setup, authentication, account usage (e.g., during electronic transaction processing), mobile device or application usage, payment information and/or service, and the like. The service provider may also provide other intelligent and/or AI systems that provide improved services to users through conversational skills and/or natural language.

These automations for self-service and other AI processes may provide assistance using an AI platform or system may be used to converse with users and/or performing predictive inferencing of outputs through LLMs, ML models, NNs, and other AI systems. For example, an LLM may be used to respond to users in a conversational manner and/or provide natural language-based search, conversation, data generation, information retrieval, and other features. To train these models, training data may be utilized, which may correspond to past or previous data records and other information. Such information may be taken from past collected, aggregated, and/or detected data, which may include data of users that may be privacy protected and/or include copyrighted data or other protected data, such as intellectual property. As such, although service providers attempt to provide strong copyright and privacy protection, service providers are required to comply with laws, regulations, and company rules or objectives governing copyright and privacy protection. As such, the use of copyright and/or privacy protected data in ML models during training and/or inferencing may pose a challenge to ensuring the data is not utilized and/or reproduced in production computing environments or at runtime with end users. Current methods for detecting and removing such information from trained ML models are limited in scope and effectiveness, often relying on manual inspection or ad-hoc techniques.

A service provider may provide and utilize a data and content deletion framework and pipeline for ML models that may address the critical need to mitigate the presence of copyrighted information, sensitive data, and concepts within ML models. In this regard, a service provider may use such a framework and pipeline and provide services to users including electronic transaction processing to process transactions, provide payments, provide content, and/or transfer funds between these users. The user may also interact with the service provider to establish an account and provide other information for the user. Other service providers may also or instead provide computing services, including social networking, microblogging, media sharing, messaging, business and consumer platforms, etc. In order to utilize the computing services of a service provider, an account with the service provider may be established by providing account details, such as a login, password (or other authentication credential, such as a biometric fingerprint, retinal scan, etc.), identification information to establish the account (e.g., personal information for a user, business or merchant information for an entity, or other types of identification information including a name, address, and/or other information), and the like.

The user may also be required to provide financial information, including payment card (e.g., credit/debit card) information, bank account information, gift card information, benefits/incentives, and/or financial investments, which may be used to process transactions for items. The account creation may also be used to establish account funds and/or values, such as by transferring money into the account and/or establishing a credit limit and corresponding credit value that is available to the account and/or card. The online payment provider may provide digital wallet services, which may offer financial services to send, store, and receive money, process financial instruments, and/or provide transaction histories, including tokenization of digital wallet data for transaction processing. The application or website of the service provider, such as PAYPAL® or other online payment provider, may provide payments and the other transaction processing services.

Once the account of the user is established with the service provider, the user may utilize the account via one or more computing devices, such as a personal computer, tablet computer, mobile smart phone, or the like. The user may engage in one or more online or virtual interactions, such as browsing websites and data available with websites of merchants. In this regard, the transaction processor or other online service provider may offer and provide computing services through data processing of account and transaction data for electronic transaction processing, as well as other data processing services for other use of computing services on websites, applications, or other online portals of the merchant. These interactions may generate and/or process data, which may include copyrighted and/or privacy protected data. The data may also be collected, stored, and used for ML model training of different ML models, which may incidentally incorporate and/or cause ML models to rely on copyrighted and/or privacy protected data. Other copyrighted and/or privacy protected data may be used with ML model training and/or as a knowledge base for LLMs (e.g., as corpora of documents for searching, training, retrieval augmented generation (RAG), and/or other knowledge bases). As such, the data accessed, stored, and/or utilized by the service provider for ML model training may include privacy protected data, such as personally identifiable information (PII), financial data, health data, transaction data and/or histories, KYC data, and the like.

The system may include a framework and pipeline that may be triggered when users or any registered entities request item removal, general deletion, or concept removal of content from an LLM model, such as user information, financial information, past historical data, etc. The framework and pipeline may also be triggered when the system determines certain data needs to be removed, such as after using such data to generate an output. The system may include different components connected and/or arranged in the framework and pipeline. For intake and content identification, the system may include a validation module, a data sources and retrieval engine, a relevant content component, a sensitive information component, and/or a credential detection component. The validation module may validate the authenticity of the requester and verify the validity of their request. This ensures that only legitimate requests are processed. An initial ML model may then be loaded to test the presence of requested content in training and/or node configuration for inferencing. The data sources and retrieval engine may connect the system with supplementary data sources, such as users'personal data, copyrighted or otherwise protected data, and external knowledge. The relevant content component may check for the relevant content including intellectual property and/or copyrighted information. This may check for copyrighted or protected content by comparing model outputs with a database of copyrighted material through a retrieval engine. The sensitive information component of the pipeline may perform sensitive information detection, which identifies sensitive information such as personally identifiable information (PII) or financial data, etc., that may have been used during training and/or is present in outputs. Lastly, the credential detection component of the system's framework and/or pipeline may scan and analyze model weights and outputs for the presence of credentials or access tokens.

Once the content has been identified that is required to be removed, the system may implement components of the framework and pipeline for ML model “unlearning.” Unlearning for ML models, such as LLMs, generally refers to a process by which certain content or data in training data used to train the model is removed from model training or “forgotten.” This reflects that the model's configurations after unlearning the content indicate or suggest that the model was trained without reliance on the specific content or data to be unlearned. For example, machine unlearning may be described as the process of removing the influence of specific training data from a trained model, that specific training data being the content or other data requested to be unlearned. On a target model, unlearning may therefore produce an unlearned model that may be equivalent or behave similar to a retrained model that is trained on the same set of initial training data without, or having removed, the content or other data to be unlearned.

For ML model unlearning and removal of copyrighted and/or privacy protected data from ML model training, knowledge base, and the like, the system may utilize a framework and pipeline of additional components. For example, concept mapping and removal may create a map of related concepts to the requested content for unlearning. Based on the detected content to be unlearned, a local ML model may be formed by modifying the relevant weights of the original target model to negate the undesired behavior caused by training on the copyrighted and/or privacy protected data. The system may identify the concepts that are copyrighted or considered trade secrets, as well as those that are privacy protected. These concepts might include specific phrases, terminologies, proprietary algorithms, or unique business methodologies. A knowledge graph with nodes for each concept and edges representing their associations may be created and graph embedding techniques may be used to map the knowledge graph to a vector space. The system may then project the outputs of the model into the same vector space and detect overlaps with the knowledge graph embeddings.

The system may include a component for unlearnable knowledge modeling. To do so, the ML model may be represented as a graph (e.g., nodes may correspond to individual neurons, edges connecting nodes may correspond to synapses) to analyze neuron connectivity and importance in processing sensitive information. The component may then analyze activation patterns and weight distributions during model inferencing, or data processing of input data to generate an output prediction, decision, or the like, to identify areas influenced by sensitive information within the model when the model generates outputs (e.g., performs inferencing during an inferencing stage). This may be used to examine how specific inputs or features activate neurons associated with the target information in the model. The synaptic weights may be analyzed to understand how information is encoded and interconnected within the model. A smaller network may be generated to pinpoint and guide the removal of particular information from the main model using the identification of the activated neurons and synaptic weights. This may form a vector that may negate the impact of identified content by dampening particular neurons and/or synapses, thereby guiding adjustments in the main model to ensure compliance or removal as needed.

Using the vector formed, relevant neurons filtering may be performed to filter the neurons and identify the neurons contributing to the undesired behavior, which may include applying negation vectors to the neurons of the model until the relevant neurons are identified. The output may correspond to a final set of neurons associated with the content and contributing to model behavior affected by training and/or inferencing based on the content to be unlearned. These neurons may then be targeted to undergo parameter dampening to weaken their connections and mitigate the unwanted content from affecting model behavior. Selective parameter dampening (SPD) may correspond to a structured parameter dampening of a trained model to selectively remove capabilities from the model. This may either iteratively prune nodes in the feed-forward layers or attention head layers of the ML model. Thereafter, an updated model may be generated with the requested content unlearned. This may correspond to an updated or retrained model with selectively weakened connections to remove unwanted content from affecting model behavior and inferencing while preserving overall performance of the model after initial training.

After model creation of the retrained model, performance evaluation may be performed to determine if the model is still behaving in an accurate and desired manner, such as by making the same or similar inferences, predictions, and outputs with the same or similar accuracy that is acceptable for model usage in production computing systems. For example, a base performance of the ML model prior to unlearning and retraining may be obtained from the original training and/or inferencing, such as a base accuracy of the model in predicting behaviors, occurrences, or other outputs. The performance evaluation may include a generalization test that evaluates the updated and retrained model's ability to generalize and prevent overfitting (e.g., behaving too closely or similarly to the training data, thereby only providing outputs relevant to the training data). As such, the base performance may be compared to a performance of the retrained model having unlearned content when performing the same tasks and/or evaluating the same data or test for predicting the behaviors, occurrences, or other outputs. Fine-tuning performance may assess the model's performance after fine-tuning on various tasks to ensure the new model maintains desired capabilities. Finally, an unlearning proof may verify that an approximate or absolute unlearning has been achieved and generate a report detailing the unlearning process and results. This component and process may send the unlearning report to the requester, providing transparency and assurance that their request has been fulfilled

To evaluate the performance of ML model after unlearning or retraining, several steps and criteria may be applied, focusing on erasure of targeted knowledge and retention of general capabilities, as well as general task performance. After the unlearning process, the ML model may be tested using a set of prompts related to the targeted knowledge or behavior that has been removed, which may be performed to evaluate whether the model can still recall or generate responses based on the unlearned knowledge. Primary metrics for performance evaluation may include the average accuracy of the model on unlearned cases where the model should show an inability to correctly predict or reproduce the removed knowledge. This confirms the successful unlearning of specific data or behaviors. Test results mat be assessed based on the absence of this targeted knowledge. If traces of the unlearned information remain, dampening processes may be further iterated until successful unlearning is achieved.

To determine if retention of general capabilities has remained intact, the average accuracy on tasks outside the scope of the unlearned knowledge may be evaluated where the ML model's should align with that of the original base model. Ideally, there should be no degradation in the model's overall functionality or retained knowledge. Various general-purpose tasks may used to assess whether the model has retained key capabilities. These tasks may include, summarization, NER, classification, reasoning, etc. The goal may be to ensure that the unlearning process only impacts the targeted knowledge without harming the model's broader competencies. Retention success ensures the unlearning process is controlled and the model continues to generalize effectively across other domains.

Since unlearning may have unintended side effects on unrelated areas of the model's performance, performance evaluation may further assess the model's performance across a variety of tasks including knowledge understanding, such as multitask language understanding used to evaluate how well the model understands and applies its general knowledge, the model's ability to provide truthful and reliable answers, and/or logical and commonsense reasoning using datasets, which requires the model to analyze and comprehend complex texts. The unlearned ML model may be evaluated on standard datasets covering tasks like classification, sentiment analysis, and text categorization. Further, model's resilience to out-of-distribution (OOD) data may be tested using simulated cases, such as mislabeled data or completely different tasks. Evaluating on OOD data may ensure the model does not generalize inaccurately due to exposure to unrelated or incorrectly labeled inputs. Finally, a GPT model may be used to assess the unlearned model's performance on two fronts, whether the model avoids generating text based on the previously unlearned knowledge, and whether the model avoids generating text based on the previously unlearned knowledge.

As such, a service provider's system may implement a framework and pipeline of components that may effectively remove or unlearn content and other data from ML models in a more efficient, automated, and accurate manner, thereby producing secure and compliant ML models. This allows for the service provider to ensure that user data maintains privacy protected standards and requirements, as well as prevents the use of copyrighted content that may present compliance and legal issues when present in ML model training and/or deployment. The system may automate the process for content unlearning, thereby reducing the time and manual efforts spent on retraining ML models while ensuring that computing resources utilized to train, generate, and deploy such models are not wasted. As such, ML models may be retrained and fine-tuned for unlearning of content and data in a more efficient and faster manner, resulting in ML models that are both compliant with data privacy and copyright requirements and accurate.

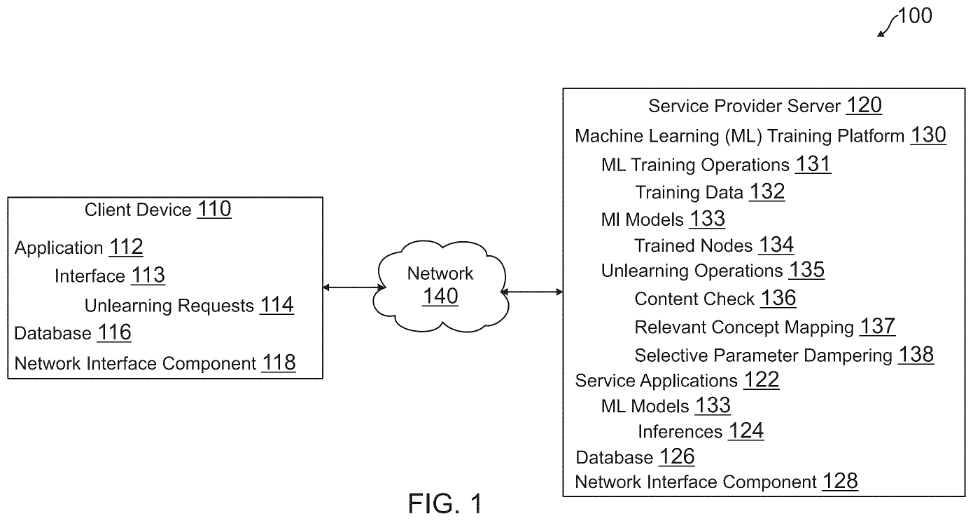

FIG. 1 is a block diagram of a networked system 100 suitable for implementing the processes described herein, according to an embodiment. As shown, system 100 may comprise or implement a plurality of devices, servers, and/or software components that operate to perform various methodologies in accordance with the described embodiments. Exemplary devices and servers may include device, stand-alone, and enterprise-class servers, operating an OS such as a MICROSOFT® OS, a UNIX® OS, a LINUX® OS, a mobile OS (e.g., iOS, Android, Google OS, etc.), a merchant and/or point-of-sale (POS) device OS, or another suitable device and/or server-based OS. It can be appreciated that the devices and/or servers illustrated in FIG. 1 may be deployed in other ways and that the operations performed, and/or the services provided by such devices and/or servers may be combined or separated and may be performed by a greater number or fewer number of devices and/or servers. One or more devices and/or servers may be operated and/or maintained by the same or different entity.

System 100 includes a client device 110 and a service provider server 120 in communication over a network 140. Client device 110 may be utilized by an entity or a user (including end-users, merchants, businesses, etc.), such as a customer of service provider server 120, to communicate with service provider server 120 over network 140. Service provider server 120 may provide various data, operations, and other functions over network 140 to provide services to merchants, users, and computing devices. In this regard, client device 110 may be used to request, directly or indirectly, deletion and/or removal of content, such as user data, from service provider server 120, where the deletion request may correspond to an unlearning of the content from one or more ML models of service provider server 120. As such, service provider server 120 may perform unlearning operations to unlearn the content from ML model training and/or inferencing, as discussed herein.

Client device 110 and service provider server 120 may each include one or more processors, memories, and other appropriate components for executing instructions such as program code and/or data stored on one or more computer readable mediums to implement the various applications, data, and steps described herein. For example, such instructions may be stored in one or more computer readable media such as memories or data storage devices internal and/or external to various components of system 100, and/or accessible over network 140.

Client device 110 may be implemented as a communication device of a user, entity, or the like that may interact with service provider server 120. Client device 110 may utilize appropriate hardware and software configured for wired and/or wireless communication with service provider server 120. For example, in one embodiment, client device 110 may be implemented as a personal computer (PC), a smart phone, laptop/tablet computer, wristwatch with appropriate computer hardware resources, eyeglasses with appropriate computer hardware (e.g., GOOGLE GLASS®), other type of wearable computing device, implantable communication devices, and/or other types of computing devices capable of transmitting and/or receiving data. Although only one device is shown, a plurality of devices may function similarly and/or be connected to provide the functionalities described herein.

Client device 110 of FIG. 1 includes and/or is associated with an application 112, a database 116, and a network interface component 118, implementations of which are discussed further below. The application 112 may correspond to executable processes, procedures, and/or applications with associated hardware. In other embodiments, client device 110 may include additional or different modules having specialized hardware and/or software as required.

Application 112 may correspond to one or more processes to execute software modules and associated components of client device 110 to provide features, services, and other operations for an individual user, such as a customer or consumer, and/or a user associated with an entity, such as a business or company, for use with service provider server 120 to request unlearning of content from ML models. In this regard, application 112 may correspond to specialized software utilized by a user of client device 110 to generate and transmit an unlearning request 114, which may correspond to a request or instruction to have particular content and/or information, such as user data, financial data, copyrighted content and/or data, privacy protected data, etc., deleted or removed from storage and use and/or unlearned from training and use by one or more ML models. In some embodiments, the request may specify an ML model and/or LLM from which the content is to be unlearned. Application 112 may also be utilized to review and address responses to unlearning, such as an unlearn proof that may be sent responsive to unlearning request 114, as well as any ML model testing and performance evaluation. As such, responsive to request 114, service provider server 120 may provide information regarding the unlearning and/or ML model retraining to application 112. Unlearning request 114 may also be automatically generated, such as after sensitive data has been used to generate an output to client device 110 or to another device or entity. In this regard, if application 112 receives an output of an ML model that is detected to include sensitive information, such as a credential or a financial account number, application 112 may automatically respond to an unlearning request for service provider server 120 to have that content unlearned from the ML model.

Application 112 may correspond to a general browser application configured to retrieve, present, and communicate information over the Internet (e.g., utilize resources on the World Wide Web) or a private network. For example, application 112 may provide a web browser, which may send and receive information over network 140, including retrieving website information, presenting the website information to the user, and/or communicating information to the website. However, in other examples, application 112 may include a dedicated application of service provider server 120 or other entity that may interact with service provider server 120 for content unlearning by ML models trained on and/or using the content. Thus, application 112 may also correspond to different service applications and the like. When utilizing application 112 with service provider server 120, application 112 may transmit unlearning request 114 to service provider server 120 and receive responses to executing unlearning operations with one or more ML models.

Client device 110 includes other applications as may be desired to provide features to client device 110. For example, these other applications may include security applications for implementing client-side security features, programmatic client applications for interfacing with appropriate application programming interfaces (APIs) over network 140, or other types of applications. Other applications on client device 110 may also include email, texting, voice and IM applications that allow a user to send and receive emails, calls, texts, and other notifications through network 140. In various embodiments, the other applications may include those that may be utilized in the course of model training, retraining, and/or content and other data unlearning. The other applications may include device interface applications and other display modules that may receive input from the user and/or output information to the user. For example, client device 110 may contain software programs, executable by a processor, including a graphical user interface (GUI) configured to provide an interface to the user. The other applications may use devices of client device 110, such as display devices capable of displaying information to users and other output devices, including speakers.

Client device 110 may further include or have access to database 116, which may correspond to different types of data storage and components including cloud computing storage nodes, remote data stores and database systems, distributed database systems over network 140, and the like used to store various applications and data. Database 116 may include, for example, identifiers such as operating system registry entries, cookies associated with application 112 and/or other applications, identifiers associated with hardware of client device 110, or other appropriate identifiers, such as identifiers used for payment/user/device authentication or identification, which may be communicated as identifying the user/client device 110 to service provider server 120.

Client device 110 includes at least one network interface component 118 adapted to communicate with service provider server 120 and/or other devices and servers. In various embodiments, network interface component 118 may include a DSL (e.g., Digital Subscriber Line) modem, a PSTN (Public Switched Telephone Network) modem, an Ethernet device, a broadband device, a satellite device and/or various other types of wired and/or wireless network communication devices including WiFi, microwave, radio frequency, infrared, Bluetooth, and near field communication devices.

Service provider server 120 may be maintained, for example, by an online service provider, which may provide computing services and operations via one or more digital platforms, applications, websites, and the like. Service provider server 120 may provide computing services to various entities, which may include intelligent automated processes, applications, and the like through ML models and AI engines. As such, during the course of service provision, service provider server 120 may provide processes for data privacy and/or copyright protections including the removal and unlearning of privacy protected and/or copyrighted data from ML model learning, training, and/or inferencing. In one example, service provider server 120 may be provided by PAYPAL®, Inc. of San Jose, CA, USA. However, in other embodiments, service provider server 120 may be maintained by or include another type of service provider.

Service provider server 120 of FIG. 1 includes and/or is associated with an ML training platform 130, service applications 122, a database 126, and a network interface component 128, implementations of which are discussed further below. ML training platform 130 and service applications 122 may correspond to executable processes, procedures, and/or applications with associated hardware. In other embodiments, service provider server 120 may include additional or different modules having specialized hardware and/or software as required.

ML training platform 130 may correspond to one or more processes to execute modules and associated specialized hardware of service provider server 120 to provide ML training operations 131 that may include one or more applications, operations, and/or components for a framework and processing pipeline to training ML models, as well as retrain ML models to unlearn certain data, such as content requested to be unlearned by unlearning request 114 and the like. In this regard, ML training platform 130 may correspond to specialized hardware and/or software used by an internal agent, data scientist, administrator, or other user associated with client device 110 to perform model training and retraining using training data 132, which may include privacy protected and/or copyrighted data that may be requested to be unlearned after ML model training. For example, ML training platform 130 may receive unlearning request 114 from client device 110 for unlearning of a particular content using the framework of service provider server 120.

Based on the request, ML training platform 130 may determine one or more of ML models 133, such as an LLM, NN, ML decision trees, and the like, which were previously trained and/or configured using training data 132 having the content to be unlearned based on unlearning request 114. As such, the determined and/or identified models of ML models 133 may rely on, such as when using a knowledge base and/or through neuron activation during inference, the content. Trained nodes 134 may therefore be required to be retrained and/or selectively dampened such that one or more of ML models 133 may be “retrained” to have unlearned the content specified by unlearning request 114. Initially, ML training operations 131 may perform model training of ML models 133 using training data 132 to train and configure trained nodes 134 for inferencing, such as predictive decisioning and outputs based on learning patterns and the like from training data 132. ML training platform 130 may provide ML training operations 131 through one or more interfaces that may be used for model training, unlearning, and other optimizations. As such, data scientists and other model training teams may train ML models 133, including one or more LLMs, AI or ML models, NNs, conversational AIs, or the like.

ML models 133 may correspond to ML models, NNs, LLMs, or other AI models, including conversational AIs, which may include trained layers having trained nodes 134 connected between layers (e.g., where trained nodes 134 may correspond to neurons connected by synapses between the layers). Trained nodes 134 may be trained based on training data 132 and selected features or variables configured to generate conversation or dialogue for chat assistance, such as for inferencing when providing computing services via service applications 122. For example, ML features may correspond to individual pieces, properties, characteristics, or other inputs for an ML model and may be used to cause an output by that ML model once the ML model has been trained using data for those features from training data 132. ML models 133 may be used for intelligent and predictive outputs based on training on a set of documents, content, or other data. LLMs may be trained on one or more corpora of general and/or domain documents, which may correspond to a general or domain-specific knowledge base used during conversational responses and natural language communications. As such, ML models 133 may include LLMs trained to provide predictive outputs, such as a response, score, likelihood, probability, or decision, associated with a particular prediction, classification, or categorization.

ML models 133 may include deep neural networks (DNNs), MLs, generative AIs, LLMs, or other AI models having trained nodes 134 configured and trained using training data 132. Training data 132 may correspond to data records that have columns or other data representations and stored data values (e.g., in rows for the data tables having feature columns) for the features. When building ML models 133, training data 132 may be used to generate one or more classifiers and provide recommendations, predictions, or other outputs based on those classifications and an ML or NN model algorithm and architecture. For example, with LLMs, training data 132 may correspond to different corpora of documents and information, which may then allow the models to respond intelligently based on learning for such corpora. The algorithm and architecture for the ML models 133 may correspond to DNNs, ML decision trees and/or clustering, conversational AIs, LLMs, generative AI, and other types of AI, ML, and/or NN architectures. The training data may be used to determine features, such as through feature extraction and feature selection using the input training data.

For example, DNN models may include one or more trained layers each include one or more of trained nodes 134, including an input layer, a hidden layer, and an output layer having one or more of trained nodes 134; however, different layers may also be utilized. As many hidden layers as necessary or appropriate may be utilized, and the hidden layers may include one or more layers used to generate vectors or embeddings used as inputs to other layers and/or models. In some embodiments, each node within a layer may be connected to a node within an adjacent layer, where a set of input values may be used to generate one or more output values or classifications. Within the input layer, each node may correspond to a distinct attribute or input data type for features or variables that may be used for training and intelligent outputs, for example, using feature or attribute extraction with the training data.

Thereafter, the hidden layer(s) may be trained to have corresponding weights, activation functions, and the like using a DNN algorithm, computation, and/or technique. For example, each of trained nodes 134 in the hidden layer generates a representation, which may include a mathematical computation (or algorithm) that produces a value based on the input values of the input nodes. The DNN, ML, or other AI architecture and/or algorithm may assign different weights to each of the data values received from the input nodes. The hidden layer nodes may include different algorithms and/or different weights assigned to the input data and may therefore produce a different value based on the input values. The values generated by the hidden layer nodes may be used by the output layer node(s) to produce one or more output values for ML models that attempt to classify and/or categorize the input feature data and/or data records. Thus, when the ML models 133 are used to perform a predictive analysis and output, the input data may provide a corresponding output based on the trained classifications.

Layers, branches, clusters, or the like of the ML models 133 may be trained by using training data 132 associated with data records of interest, which may require retraining through selective parameter dampening using the operations provided herein when unlearning request 114 is received. By providing training data, the nodes in the hidden layer may be trained (adjusted) such that an optimal output (e.g., a classification) is produced in the output layer based on the training data. By continuously providing different sets of training data and/or penalizing the ML models 133 when the outputs are incorrect, the ML models 133 (and specifically, the representations of the nodes in the hidden layer) may be trained (adjusted) to improve its performance in data classifications and predictions. Adjusting of the ML models 133 may include adjusting the weights associated with trained nodes 134 in the hidden layer. After training and/or during unlearning of content and other data, trained nodes 134 may be adjusted to perform unlearning of content after training, as discussed herein.

In order to perform selective parameter dampening or other operations for retraining of ML models 133 by reconfiguring, dampening, or adjusting parameters, activations and/or activation functions, values, etc., of trained nodes 134, unlearning operations 135 may be performed to reconfigure trained nodes 134. Unlearning operations 135 may initiate with a content check 136, which may determine the content specified by unlearning request 114 or other request for unlearning of data, and where the content may be present in training data, an output by the ML model, or source code and/or source code files of the ML model. Content check 136 may correspond to a content detection check that may identify the content to be unlearned from one or more data sources, such as the specific user data or copyrighted work, and may analyze the model's training data, outputs, and/or code for the content. In some embodiments, a content detection check ML model or other AI process may be used to perform content check 136, such as a content detection check of whether the content for unlearning is present in training data 132, an output by ML models 133, or a source code file for ML models 133.

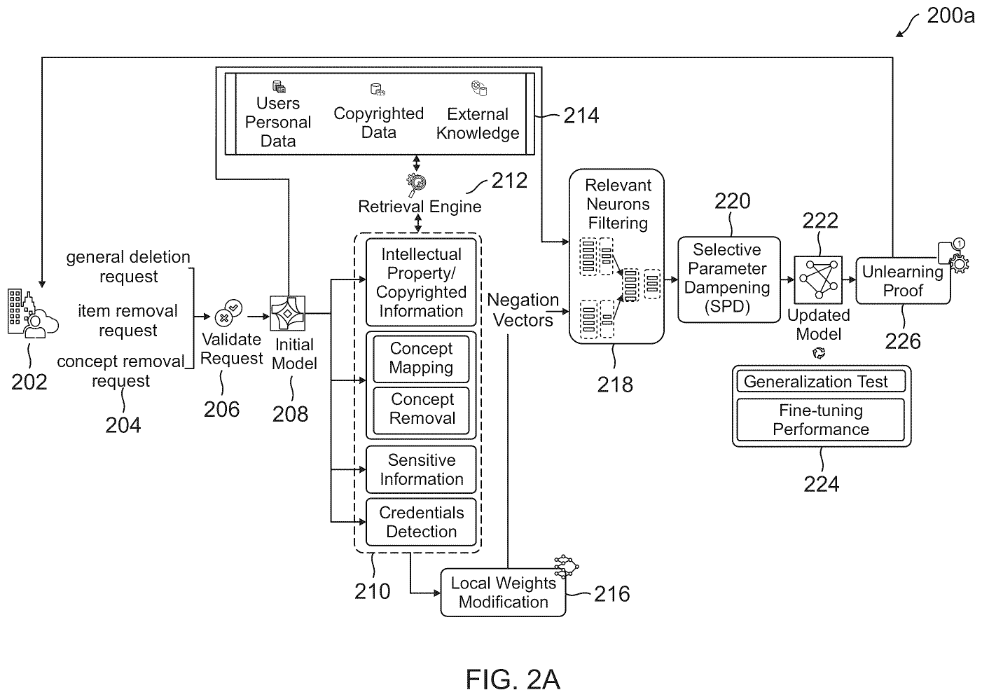

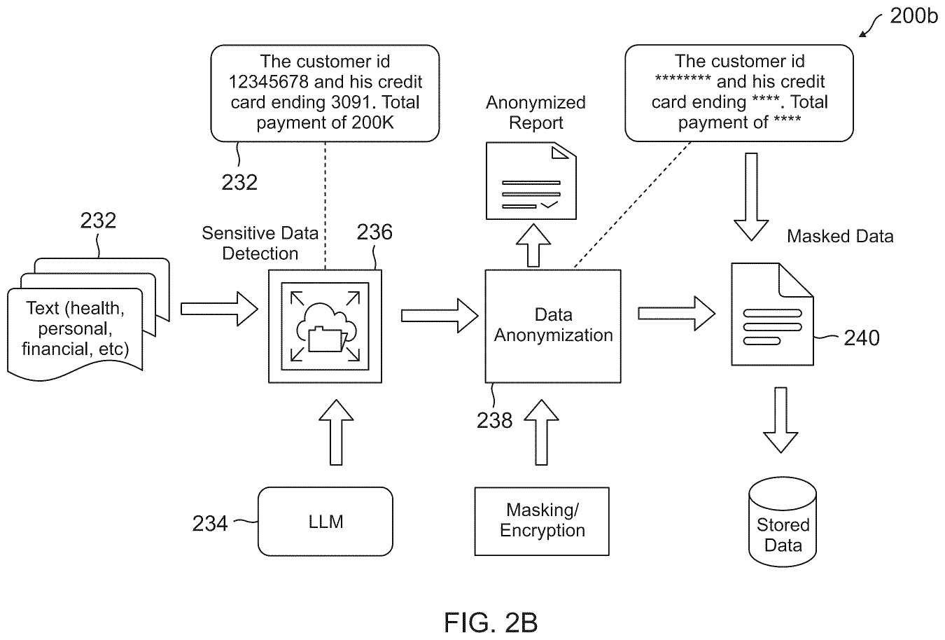

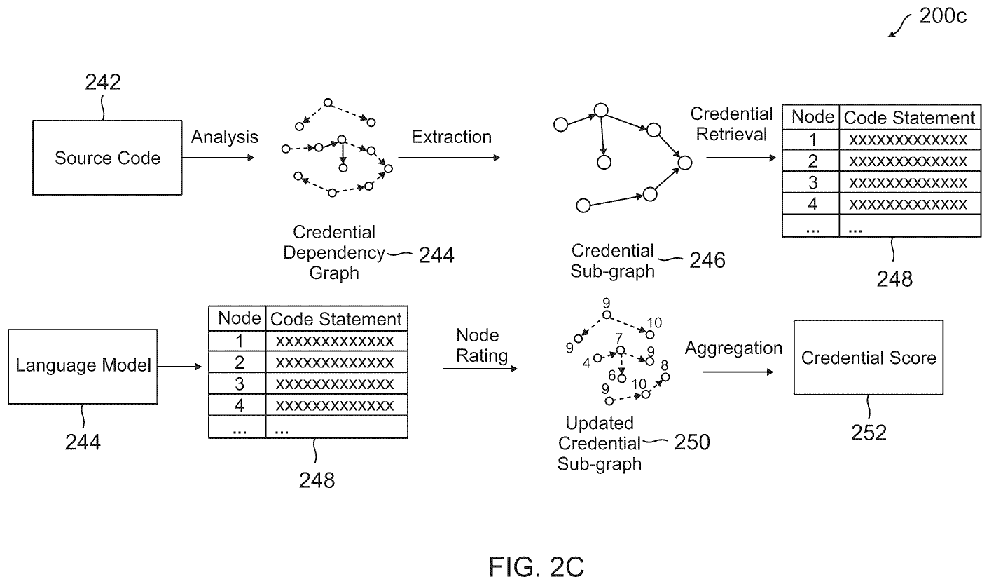

Once identified, relevant concept mapping 137 may be performed to map the content to relevant concepts learning by the ML model. Relevant concept mapping 137 may include mapping the relevant concepts by projecting model outputs in a vector space and/or constructing a knowledge graph in the vector space so that overlaps may be determined. Prior to performing a selective parameter dampening 138, relevant concept mapping 137 may be utilized to identify neuron activations of the relevant concepts and identifying of a negation vector to negate the impact of the concepts through dampening of those neurons. Thereafter, selective parameter dampening 138 may be executed to dampening the parameters of those neurons associated with the concept when inferencing is performed by the ML model. The operations of ML training platform 130 for unlearning operations 135 are discussed in further detail below with regard to FIGS. 2A-4.

Service applications 122 may correspond to one or more processes to execute modules and associated specialized hardware of service provider server 120 to process a transaction and/or provide other computing services to users. For example, service applications 122 may be used to process payments and other services to one or more users, merchants, and/or other entities for transactions, where ML training platform 130 may be used for training of ML models 133 utilized through service applications 122 for inferences 124 and other outputs. In this regard, accounts of users and entities may be used to send and receive payments, including those payments that may be enabled through a website and/or application of users, merchants, and other transaction participants. A payment account may be accessed and/or used through a browser application and/or dedicated payment application executed by a device, such a payment and/or digital wallet application. Service applications 122 may process payments and may provide transaction histories to client device 110 and/or another user's device or account for transaction authorization, approval, or denial of the transaction for placement and/or release of the funds, including transfer of the funds between accounts based on compliance investigations.

Further, service applications 122 may provide different computing services, including social networking, microblogging, media sharing, messaging, business and consumer platforms, etc. These computing services may be used by customers and users, and therefore ML models 133 may be used to provide intelligent outputs through inferencing 124 utilized during the provision of computing services to users and devices. In this regard, ML models 133 may assist with intelligent and automated computing services provided to users through predictive decisioning and/or outputs when performing inferencing 124. As such, ML training operations 131 may be used for training of ML models 133 to provide accurate models. Further, unlearning operations 135 may provide unlearning of content from ML models 133 so that service applications 122 are compliant with privacy protection and copyright rules, regulations, and laws, as well as do not utilize data specific data requested to be unlearned by users.

Service applications 122 as may provide additional features to service provider server 120. For example, service applications 122 may include security applications for implementing server-side security features, programmatic client applications for interfacing with appropriate APIs over network 140, or other types of applications. Service applications 122 may contain software programs, executable by a processor, including one or more GUIs and the like, configured to provide an interface to the user when accessing service provider server 120, where the user or other users may interact with the GUI to view and communicate information more easily. Service applications 122 may include additional connection and/or communication applications, which may be utilized to communicate information to over network 140.

Additionally, service provider server 120 includes or may access database 126. Database 126 may store various identifiers associated with client device 110. Database 126 may also store account data, including payment instruments, financial information, account balances, and authentication credentials, as well as transaction processing histories and data for processed transactions. Database 126 may include information used during AI service provision by ML models 133 and the like, such as trained models, packages, and/or model artifacts, knowledge base documents and data, and the like. Although database 126 is shown as residing on service provider server 120 as a database, in other embodiments, other types of data storage and components may be used including cloud computing storage nodes, remote data stores and database systems, distributed database systems over network 140 and/or of a computing system associated with service provider server 120, and the like.

Service provider server 120 may include at least one network interface component 128 adapted to communicate client device 110 and/or other devices and servers over network 140. In various embodiments, network interface component 128 may comprise a DSL (e.g., Digital Subscriber Line) modem, a PSTN (Public Switched Telephone Network) modem, an Ethernet device, a broadband device, a satellite device and/or various other types of wired and/or wireless network communication devices including WiFi, microwave, radio frequency (RF), and infrared (IR) communication devices.

Network 140 may be implemented as a single network or a combination of multiple networks. For example, in various embodiments, network 140 may include the Internet or one or more intranets, landline networks, wireless networks, and/or other appropriate types of networks. Thus, network 140 may correspond to small scale communication networks, such as a private or local area network, or a larger scale network, such as a wide area network or the Internet, accessible by the various components of system 100.

FIGS. 2A-2C are exemplary computing architectures 200a-200c of a service provider that performs selective parameter dampening to unlearn and/or remove content learned by ML models, according to an embodiment. Computing architectures 200a-200c may include components of service provider server 120 that may be utilized when responding to unlearning requests from client device 110 to unlearn content from one or more trained ML models, as discussed in reference to system 100 of FIG. 1. In this regard, computing architectures 200a-200c show an end-to-end processing pipeline of components in a framework for ML unlearning of content, which may include components for content detection and identification in data associated with training and/or inferencing by ML models.

Referring now to computing architecture 200a of FIG. 2A, initially a request is received from a user 202 in computing architecture 200a, such as a request that specifies the nature of the content to be removed (e.g., copyrighted or otherwise protected, privacy protected data, specific designated data, etc.). The request may correspond to an API call having different API and data fields, such as a requester identifier (ID, type, contact information (e.g., email, phone address, etc.), content type or identification (e.g., detailed, description, instances, related documents), date of request, legal references, and/or verification token, which may be provided by the calling device as strings in the API calls message fields or body. For example, a request type 204 may be identified when the request from user 202 is received, such as a general deletion request, an item removal request, or a concept removal request, although other types of requests may also be received and used.

A request validation 206 is performed to validate the request to unlearn the specified content from an initial model 208, such as a designated ML model or an ML model found to be trained on the content and/or utilizing the content during inferencing. To validate requests, a neural token exchange (NTE) may be used to verify the identity of the requester. The NTE may check the requester identifier and verification token against known behavior patterns to validate user behaviors, such as login times, device usage, and/or interaction history. If this is successful, a contextual verification module may be used that performs a contextual role-based verification for dynamic request context validation. This may analyze the requester type and contact information against external verification sources to verify the requester, and may ensure contextual alignment of the request type and content type with requester privileges. As such, the contextual verification module may consider factors including location, time, device, and past requests for validation.

Lastly, a request logging and validation module may use temporal blockchain stamping for immutable request logging by logging the request data and detailed on a blockchain with a unique identifier, as well as validate ownership via related documents and legal references against the blockchain and legal databases. This may approve and log requests once ownership and legitimacy are verified. Each of these modules for request validation 206 may utilize a data store that stores user records, roles, previous requests, and verified documents. The data store may also maintain behavioral patterns for NTE and contextual information for context validation, as well as keep a ledger of all the tamped requests for the blockchain.

For concept mapping and removal 210, processes may be used for checking initial model 208 for the content to be unlearned, such as copyrighted and/or privacy protected content and other data. This may include connecting the test modules with supplementary data sources so that identification of content designated for unlearning may be performed with regard to training data, model outputs, source code, and the like. A retrieval engine 212 may be used with data sources 214 to check initial model 208, as well as one or more other ML models, for the relevant content and whether the content is present and requires unlearning. With intellectual property, copyrighted, or otherwise protected content, concept mapping and removal may include a module to check copyrighted content in model behavior and/or usage by comparing model outputs with a database of intellectual property and/or copyrighted content and material from data sources 214 through retrieval engine 212.

In this regard, a user input or query may be provided to a language model or other ML model, which may generate text output or other model output including prediction and/or classifications (as well as AI images, video, etc.). This output may then be checked against a database of copyrighted material using a similarity check algorithm for text or other content similarities. A flagging mechanism may be used to flag and report such matches. Further, concept mapping and removal 210 may include processes for sensitive information detection and credentials detection, which may analyze training data and source code, respectively. The processes for sensitive information and credentials detection of concept mapping and removal 210 are shown in further detail with regard to FIGS. 2B and 2C below.

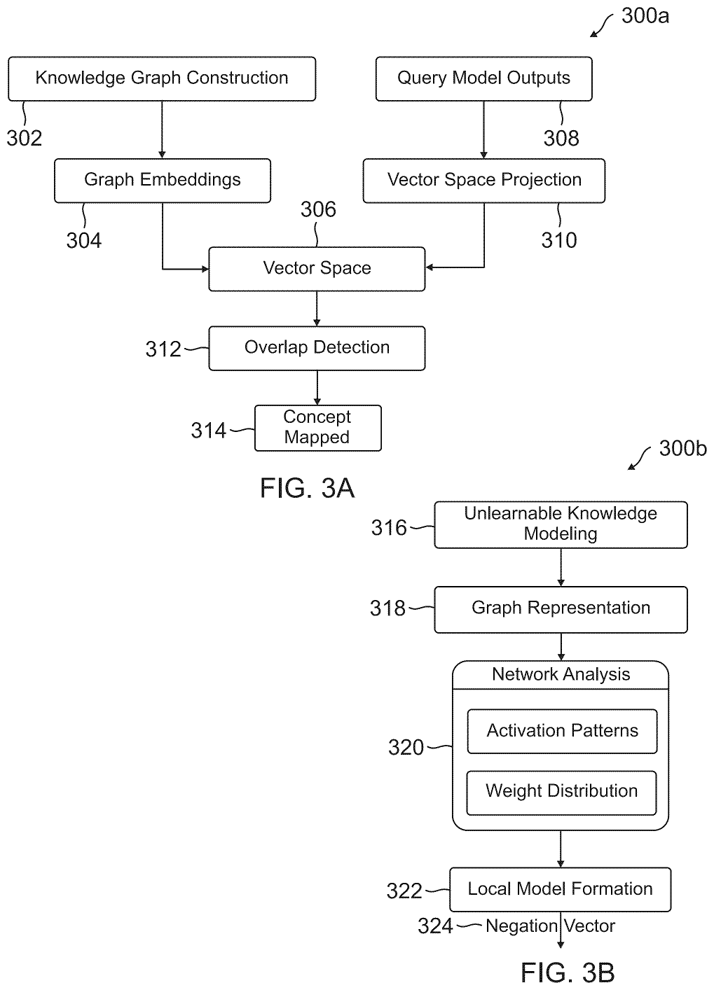

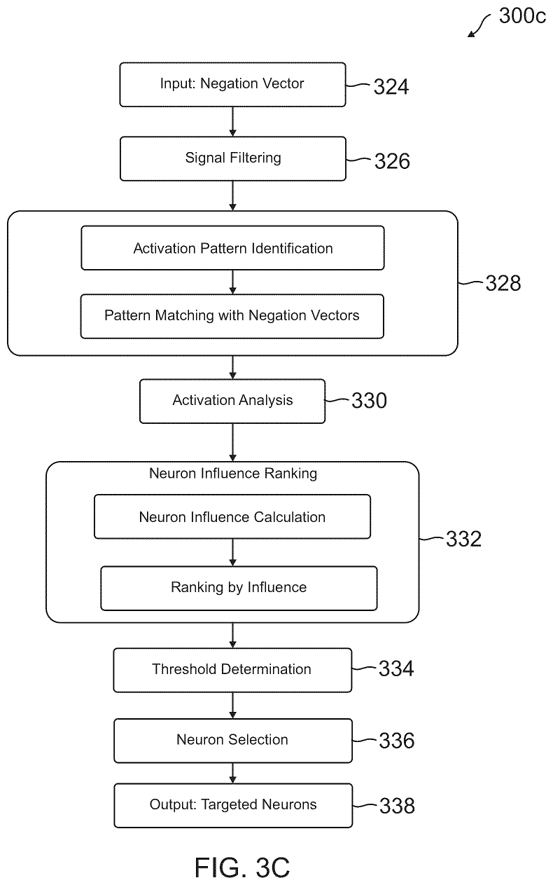

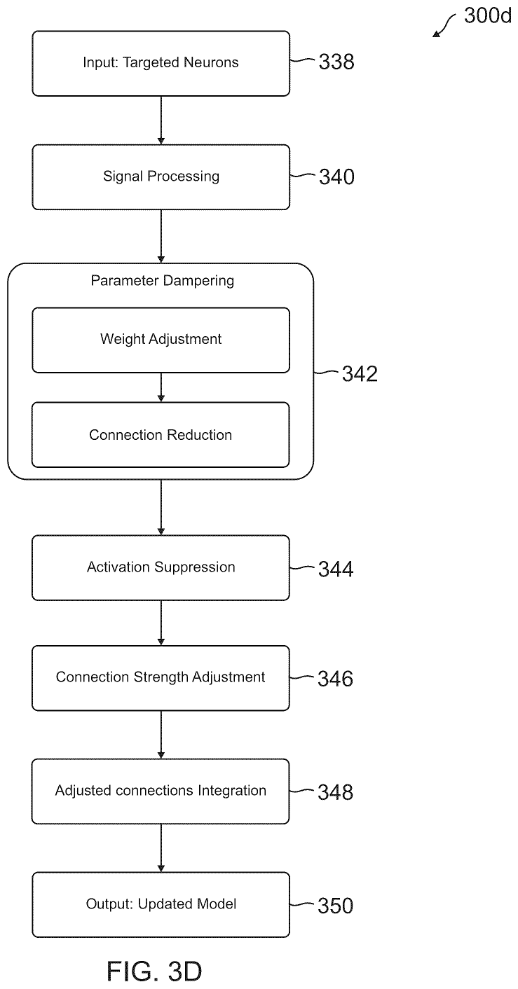

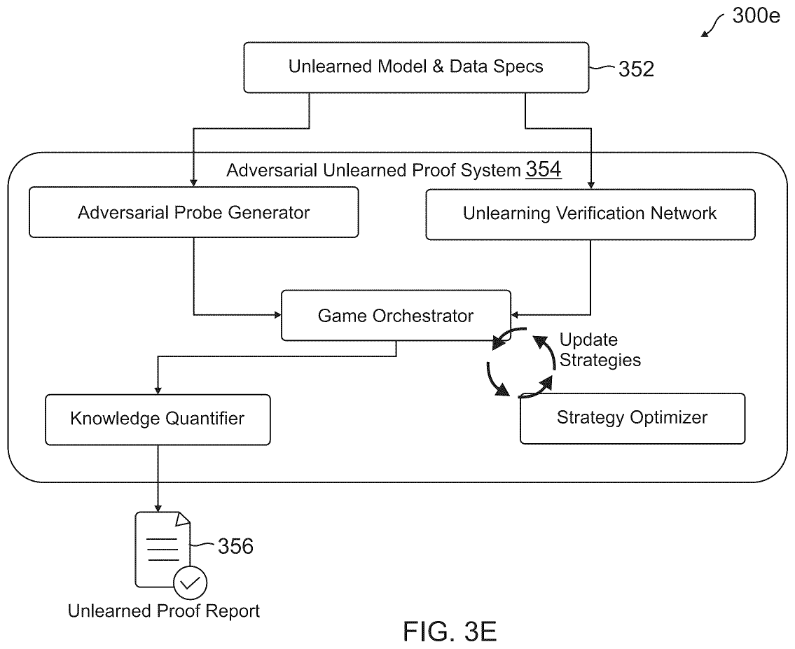

Once the content is identified, concept mapping and removal 210 may map the content to concepts, such as by creating a map of related concepts to the requested content for comprehensive unlearning. In this regard, a knowledge graph of concepts from the content may be generated, which may be used to compare with model outputs, such as in a vector space (e.g., by creating embeddings or vectors from words/text of model outputs, using embedding/vector outputs of models, etc.). Concept mapping and removal 210 may perform unlearnable knowledge modeling to determine activation patterns and weight distributions of the model that are influenced by the content to be unlearned, such as those neurons and synapses used during model inferencing that are affecting by the content. This allows a local weights modification to generate one or more negation vectors, which may be utilized for model unlearning. These processes are shown in further detail with regard to FIGS. 3A-3C below.

Once the negation vectors are generated, initial model 208 and the outputs from local weights modification 216 (e.g., negation vectors, concept mapping, activated neurons, etc.) may be processed using a relevant neurons filtering 218. This process may filter neurons of the ML model to identify those neurons selected for dampening based on their effect during model processing and inferencing. For example, this may include analyzing those neurons that are activated and identifying those having an influence ranking that meets or exceeds a threshold. Once identified, relevant neurons filtering 218 may provide those neurons to a selective parameter dampening (SPD) 220 that may suppress or dampen the effect and use of those neurons when the model is executed. SPD 220 may be performed by weakening connections, adjusting weights, suppressing activation, and the like. An updated model 222 may be output from initial model 208 after SPD 220, which may correspond to the retrained and/or reconfigured model having unlearned the specified content. A performance evaluation 224 may be performed, which may run and test the model for model performance and accuracy, such as through a generalization test, as well as perform model fine-tuning. Further, an unlearning proof 226 may be generated that may demonstrate the unlearning of the content by the model and adherence of the model to data privacy and/or copyright requirements. The processes for SPD 220 and unlearning proof 226 are shown in further detail with regard to FIGS. 3D and 3E below.

Referring now to computing environment 200b of FIG. 2B, sensitive information 232 may be flagged and masked for removal from a trained model without retraining the model. In this regard, sensitive information 232 may correspond to personal user data, such as personally identifiable information (PII), health information, financial information, identifiers, and the like. An LLM may be capable of flagging and logging sensitive information 232 during both training and inference, for example, using a sensitive information detection 236. Predefined keyword matching may be used with a list of sensitive keywords (e.g., social security numbers, payment card numbers, etc.) to scan text for sensitive information and provide a data anonymization 238, such as by masking the data so that the data no longer appears with the sensitive portions in sensitive information 232. As such, when utilized as a knowledge base, sensitive information 232 may not include the sensitive portions. Masked data 240 may then be output and stored for model consumption during training and/or inferencing.

Additionally, a gradient reversal process or other technique may be used to selectively “forget” data points by reversing the contribution of identified sensitive data points from model gradients. Gradient reversal may allow the ML model to learn useful representations for the primary task (e.g., classification), while simultaneously preventing the model from learning irrelevant or harmful features (e.g., domain-specific features that hinder generalization). As such, gradient reversal unlearns specific data points by discouraging the model from focusing on domain-specific (or irrelevant) features, leading to more generalized representations. Selective parameter dampening may refer to controlling the scale or intensity of the gradient updates for specific parameters or parts of a model, allowing some parameters to be updated more aggressively while others are updated more conservatively. Incorporating gradient reversal with selective parameter dampening consider that after reversing the gradient, some parameters are updated more slowly (dampened) while others are left to update normally or even accelerated. This would allow finer control over how different parts of the network learn.

Referring now to computing environment 200c of FIG. 2C, credentials detection in source code 242, such as source code data files and the like, may be performed using a language model 244. Credentials detection in computing environment 200c may be performed to identify where credentials may have incidentally been utilized in training data and may therefore be utilized during model inferencing and as potential model outputs. Using files for source code 242, a credential dependency graph (CDG) 244 may be generated for each code function through code analysis. Each node in CDG 244 may correspond to a statement expression. CDG 244 may then be sectioned or sliced into credential subgraphs 246, each of which corresponds to a single variable in the model's program and source code 242. Based on credential subgraphs 246, code statements are collected, creating a set of code statements 248 that are either control or data-dependent on credential variables. Set of code statements 248 may then be rated by language model 244 using an initial prompt or request (e.g., an LLM prompt) that is designed based on the purpose of the target model and program. Statement ratings 248 may reflect the significance of the statements in terms of their impacts toward potential non-control data attacks against the target model and program. Statement ratings 248 may be used to update credential subgraphs 246, serving as node score, to generated updated credential subgraphs 250. Finally, the score of the variables may be computed by aggregating the node scores of updated credential subgraphs 250 using an aggregation algorithm based on the graph topology. To confirm a credential score variable, subsequent manual review may be utilized for those with the highest ratings.

FIGS. 3A-3E are exemplary diagrams 300a-300e of concept mapping and node identification for selective parameter dampening, according to various embodiments. Diagrams 300a-300d include processes for mapping concepts to content so that specific neurons in ML models may be identified and selectively dampened for unlearning operations 135 executed by ML training platform 130 of service provider server 120 in system 100 of FIG. 1. As such, diagrams 300a-300d show processes by which neurons may be selectively dampened and an ML model may be retrained and/or adjusted for evaluating a performance and generating an unlearning proof of content unlearning.

Referring now to diagram 300a of FIG. 3A, concept identification and mapping may be performed in order to identify outputs of a model that overlap with concepts from content to be unlearned. In this regard, a vector space may originally be taken or utilized, which may correspond to a set of elements in which vectors may be represented by values of their corresponding elements, which allows for vector comparison, additional, scalar multiplication, and the like. This vector space may have a dimensionality of the set of elements corresponding to the vectors and may allow for vectors for concepts from content to be compared to outputs from models, such as using similarity score functions and/or algorithms for comparison, detecting overlap, and the like. As such, concept identification may initially be performed with the content, which may seek to identify the concepts that are privacy protected, copyrighted, or the like. These concepts may correspond to specific phrases, terminologies, proprietary algorithms, or unique business methodologies. The concepts may be extracted from the content, such as text of the content, and/or using tools including knowledge graphs, semantic networks, and the like to represent relationships between concepts.

Using the words, phrases, and the like for the concepts, a knowledge graph construction 302 may be performed, which may correspond to a collection of interlinked concepts or other data that represents the content in a graph form. Each node in the knowledge graph may correspond to a concept with edges representing associations between the concepts. Graph embeddings 304 may be generated by converting the knowledge graph to one or more vectors and/or mapping the knowledge graph to a vector space 306, such as by converting the knowledge graph and concepts to vectors representing the concepts and their relationships in vector space 306. This may use a graph embedding technique to map the knowledge graph into vector space 306.

Additionally, model outputs may be determined from a set of inputs, such as inputs associated with the content and/or designed to elicit responses by the model that are associated with the content for unlearning. As such, query model outputs 308 may be generated and/or determined, which may also be projected into vector space 306 through a vector space projection 310, such as by vectorizing text, creating text embeddings, and/or otherwise converting outputs of an ML model, such as an LLM, to a vector in vector space 306. Using the projected vectors in vector space 306, overlap detection 312 may be performed to identify those model outputs that include concepts associated with the content to be unlearned. As such, mapped concepts 314 for unlearning may be identified for further processing.

Referring now to diagram 300b of FIG. 3B, an unlearnable knowledge modeling 316 may be performed according to diagram 300b so that specific neurons and neuron activity occurring during model execution and inferencing may be determined, which may lead to identification of the model parameters requiring dampening for model unlearning of the requested content. In this regard, a graph representation 318 of the ML model may be generated for unlearnable knowledge modeling 316. This may represent the nodes of the ML model as neurons and the edges as synapses, which allows for analysis of connectivity and importance in processing sensitive information or other privacy protected or copyrighted content requested for unlearning.

A network analysis 320 may analyze activation patterns and weight distributions to identify areas influenced the by content for unlearning, where those patterns and distributions may be analyzed in graph representation 318 when model execution and inferencing is performed for the model outputs that have been mapped to and overlap with the concepts from the content. Activation patterns for network analysis 320 may correspond to the activation of neurons for specific inputs or features when the model generates or provides the corresponding outputs. Weight distributions may include an analysis of synaptic weights to understand how information is encoded and interconnected within the model when executing, such as those synapses associated with the activated neurons. A local model formation 322 may train a smaller ML model, LLM, NN, or the like for the activated neurons, which allows for pinpointing of the specific neurons and guiding of removal of particular information from the main ML model. Local model formation 322 may be used to generation a negation vector 324 that negates the impact of the identified content, guiding adjustments in the main model to ensure compliance or removal as needed. Negation vector 324 is then used for further system processing, as shown in diagram 300c of FIG. 3C.

In diagram 300c, targeted neurons may be identified for SPD or other adjustments and reconfigurations for model unlearning. In this regard, neurons may be filtered using negation vector 324 to send signals to the model to weaken connections associated with particular model behavior, such as generating outputs or making inferences that use or rely on the unbearable content and/or training based on the unlearnable content. The input for relevant neurons filtering in diagram 300c may correspond to negation vector 324, and a signal filtering 326 may initially process input signals to improve their quality and extract relevant information for more effective pattern recognition. A pattern recognition 328 may then perform activation pattern identification and matching of patterns with negation vectors. For example, patterns in neuron activations that correspond to the content for unlearning may be identified and compared with negation vector 324 to ensure these align and correspond to the neurons for targeting during SPD.

An activation analysis 330 may then examine neuron activation patterns and activation strength from pattern recognition 328 to identify the information flow within the ML model, such as when processed by the neurons in the different NN layers. A neuron influence ranking 332 may utilize the data from activation analysis 330 to calculate or otherwise quantify the influence of each neuron based on its activation patterns and connections. Neuron influence ranking 332 may further rank neurons to prioritize those that are most critical to the content for unlearning, such as those that are most strongly activated or associated with inferences or outputs using, relying on, or including the content. A threshold determination 334 may be used to set and/or adjust a threshold for neuron selection for SPD based on the ML model, model characteristics, content, or the like. Finally, based on the threshold from threshold determination 334, a neuron selection 336 may select those neurons for SPD or further processing if the neurons meet or exceed the scoring threshold. The output of diagram 300c may then correspond to targeted neurons 338, or a set of neurons that are to be targeted for SPB or other operation to weaken their connections and mitigate the content for unlearning from being used in the model's inferencing, outputs, or the like. Targeted neurons 338 are then used for further processing, as shown in diagram 300d of FIG. 3D.

In diagram 300d, a process to selectively dampen certain parameters of an ML model (e.g., by applying SPD of identified neurons activated when the model generates inferences associated with the content to be unlearned) and generation of an updated or retained model is shown. Initially, targeted neurons 338 are taken as input for an SPD process. This SPD process may selectively remove capabilities from the model by dampening the parameters of targeted neurons 338. A signal processing 340 is performed to isolate and enhance the neural signals relevant to the targeted parameter dampening. Parameter dampening 342 may then adjust weights and weaken connections identified for dampening. For example, weight adjustment for parameter dampening 342 may adjust weights for connections of associations between neurons, thereby minimizing their interactivity and use during data processing. Connection reduction may gradually reduce the strength of the connections to be dampened.

After parameter dampening 342 is performed, activation suppression 344 may further be utilized to dampening the effect and usage of certain neurons, such as by suppressing the activation of neurons through adjustment of activation functions and the like of those neurons. In this regard, activation suppression 344 may perform targeted inhibition of neural activations to suppress specific unwanted neuron activity associated with the content to be unlearned. A connection strength adjustment 346 may dynamically adjust the strength of weakened neural connections while preserving model stability and performance. This then may lead to an adjusted connection integration 348 to incorporate the dampening adjustments back into the main model. As such, the output may correspond to an updated model 350 that has selectively weakened connections to remove unwanted content while preserving overall performance. To test performance, one or more performance tests may be performed, which may test updated model 350 with one or more inputs and/or prompts to verify the targeted knowledge or behavior is still correct and accurate. The performance tests may compare a base performance of the ML model prior to retraining and unlearning of content to the model's performance on the same or similar tasks after the retraining and unlearning. If accuracy and/or the targeted knowledge or behavior is not maintained, dampening may be reiterated as needed. This may ensure the general capabilities of the model are retained, such as through testing on benchmark tasks including summarization, named entity recognition (NER), classification, and reasoning.

Referring now to diagram 300e of FIG. 3E, a process for providing a proof of unlearning to verify content has been unlearned from an ML model is shown. Diagram 300e may be used to verify the approximate or absolute unlearning, which may be sent to the requester and/or stored for auditing purposes and review. An unlearned model and data specification 352 is taken as input to an adversarial unlearning proof system 354, which may process unlearned model and data specification 352 to generate an unlearning proof report 356. An adversarial probe generator of adversarial unlearning proof system 354 may analyze the characteristics of the data to generate a diverse set of adversarial probes to expose residual knowledge and employ generative models to create edge-case probes. These may be used with an unlearning verification network, such as a specialized network with multiple detection heads, designed to identify traces of unlearned knowledge. A game orchestrator of adversarial unlearning proof system 354 may then manage an adversarial “game” or challenge between the probes and the unlearned model to challenge or test the model on certain prompts, inputs, or the like designed to elicit use of the unlearned content. The model responses may be provided to the unlearning verification network for tracking, and a residual knowledge quantifier may measure successful detections, estimate residual knowledge, and calculate confidence intervals for unlearning effectiveness. Further, a strategy optimizer may optimize probing and detection strategies via reinforcement learning, dynamically adjusting the difficulty and focus of adversarial probes. Thereafter, adversarial unlearning proof system 354 may generate unlearning proof report 356 for provision to the requester, storage, or other use in proving the unlearning of the content.

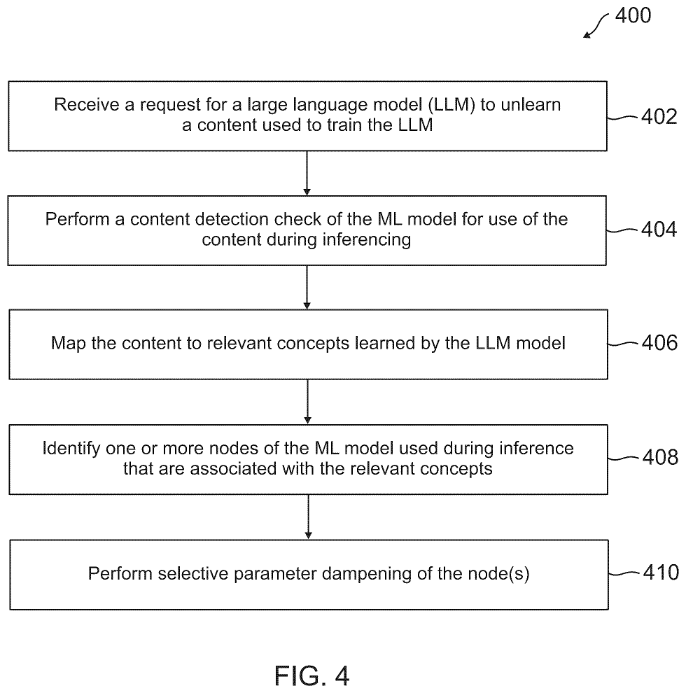

FIG. 4 is a flowchart 400 for data privacy protection and removal for AI model training and deployment, according to an embodiment. Note that one or more steps, processes, and methods described herein of flowchart 400 may be omitted, performed in a different sequence, or combined as desired or appropriate.

At step 402 of flowchart 400, a request for an ML model to unlearn a content used to train the ML model is received. In system 100 of FIG. 1, client device 110 may transmit unlearning request 114 to service provider server 120 so that a content may be unlearned from ML models 133 by reconfiguring, retraining, and/or dampening parameters of trained nodes 134. Unlearning request 114 may specify the particular content, such a copyrighted work, a credential, or the like. However, unlearning request 114 may more generally request unlearning of user data, financial data, or the like. As such, ML training platform 130 may connect to one or more data sources so that the content and other data may be determined, which may then be used at step 404 for determination of which of ML models 133 and where the content was used for training and/or may be used during inferencing by one or more of ML models 133. Prior to further processing unlearning request 114, unlearning operations 135 may further validate the request, such as by authenticating the user and/or verifying an identity of the user so that the unlearning of the content may be validated.

At step 404, a content detection check is performed of the ML model for use of the content during inferencing. Unlearning operations 135 of ML training platform 130 may be invoked to determine a process by which the content requested to be unlearned may be identified and the ML model retrained by selectively dampening particular parameters. Content check 136 may detect a presence of the content when ML model training was performed and/or inferencing is performed by the model (e.g., the model is executed, and neurons are activated/utilized to process input data for ML features). Content check 136 may analyze training data used to train the model for the presence of the content specified or associated with unlearning request 114. Additionally, to determine what content was used when the ML model was configured and what the ML model utilizes during execution and inferencing, outputs of the ML model and source code files and data may be checked for the presence of any content associated with unlearning request 114 that is requested to be unlearned. For example, components may be used for copyrighted information detection, sensitive information flagging, and/or credential detection, although other components for detection of privacy protected and/or copyrighted data in ML model usage may also be utilized.

As such, content detection and content check 136 may refer to the ability of a model to identify and classify specific types of content in a dataset. It takes content-based input as either text, audio, or video and perform several pre-processing tasks to remove unwanted and unnecessary information from these content-based input. The pre-processing input content is passed for a feature extraction mechanism, which gives important information and linguistics insights of the input content based on the hand-crafted or neural network-based extracted feature. Accordingly, input content may be transformed into input feature vectors and forwarded to the selected ML model for training. The performance of the content-based model is evaluated to show result inferences in terms of different evaluation metrices. Further, continuous hyperparameter tuning may be performed to improve the model performance during testing of the model for a content classification task. As such, a content detection ML model may be used for such detection, flagging, and/or identification. Once identified, that particular content used by the ML model during training and/or inferencing may then be utilized to determine processes for the ML model to unlearn the content.

At step 406, the content is mapped to relevant concepts learned by the LLM model. Relevant concept mapping 137 may be executed by unlearning operations 135 of ML training platform 130, which may include generating a knowledge graph of the content and/or mapping concepts for the content to graph embeddings such that the concepts may be mapped, projected, or placed in a vector space. Outputs of the ML model may be projected into the same vector space such that overlaps between the concepts from the content and outputs by the ML model (e.g., concepts learned by the ML model) may be identified. These relevant concepts learned by the ML model may then be identified from the overlap of the mapped concepts and outputs.

At step 408, one or more nodes of the ML model is identified used during inference that are associated with the relevant concepts. Once the relevant concepts learned by the ML model have been identified from mapping in the vector space, neuron connectivity and importance in processing the content to be unlearned may be analyzed for importance and activation when the ML model is executed. The ML model may be represented as a graph where the neurons and synapses may be represented by nodes and edges, respectively, in a vector or graph space. Selective parameter dampening 138 of unlearning operations 135 may then process the graph of the ML model to identify and analyze activation patterns and weight distributions of the ML model when executed and performs inferencing associated with the relevant concepts and related outputs.

For example, when the outputs associated with the content are provided by the ML model, such as when the ML model is executed and performs inferencing associated with the relevant concepts, certain neurons and synapses may be used, such as when activation functions and weights cause certain neurons to activate and feed weighted data forward to further neurons and layers. This data may correspond to embeddings based on activations of neurons from the input data weighted based on corresponding synaptic weight. These activation patterns show how specific inputs or features active neurons associated with the target information (e.g., output corresponding to the learned concept), while weight distribution analyzes and shows the synaptic weights to understand how information may be encoded in different encodings or embeddings interconnected within the model.

At step 410, selective parameter dampening of the node(s) is performed. Based on node identification, a local model may be trained and formed that may pinpoint the specific activated nodes for the learned concept. Selective parameter dampening 138 of unlearning operations 135 may then form a negation vector to negate the impact of the identified content and the relevant learned concepts by the ML model. The negation vector may then guide adjustments to the main model to unlearn the content, such as by performing a relevant neurons filtering (e.g., identifying of the neurons for dampening in the ML model), and then selectively dampening those neurons. The negation vector may be used to provide signals to indicate the patterns associated with the unwanted content, where pattern recognition may be used to identify patterns in the neuron activations, rank an influence of those neurons, and make a threshold decision (e.g., whether the ranked or scored influence meets or exceeds a threshold) of whether those neurons require dampening.

Once the targeted neurons are identified, dampening may be performed by adjusting weights, reducing connection strength, suppressing activations and/or performing activation function weakening, and the like. The output may correspond to a retrained and/or updated model having dampened parameters for particular neurons, which may weaken or eliminate the effect of the content in ML model inferencing and decisioning. The updated model may then be tested for accuracy and/or evaluated for performance of the target model capabilities. The performance evaluation may be output to determine whether the model is usable and/or accurate for the model's purpose. Further, an unlearning proof may be generated by demonstrating the content identified and the selectively dampened parameters, which may be reported and utilized to respond to unlearning request 114.

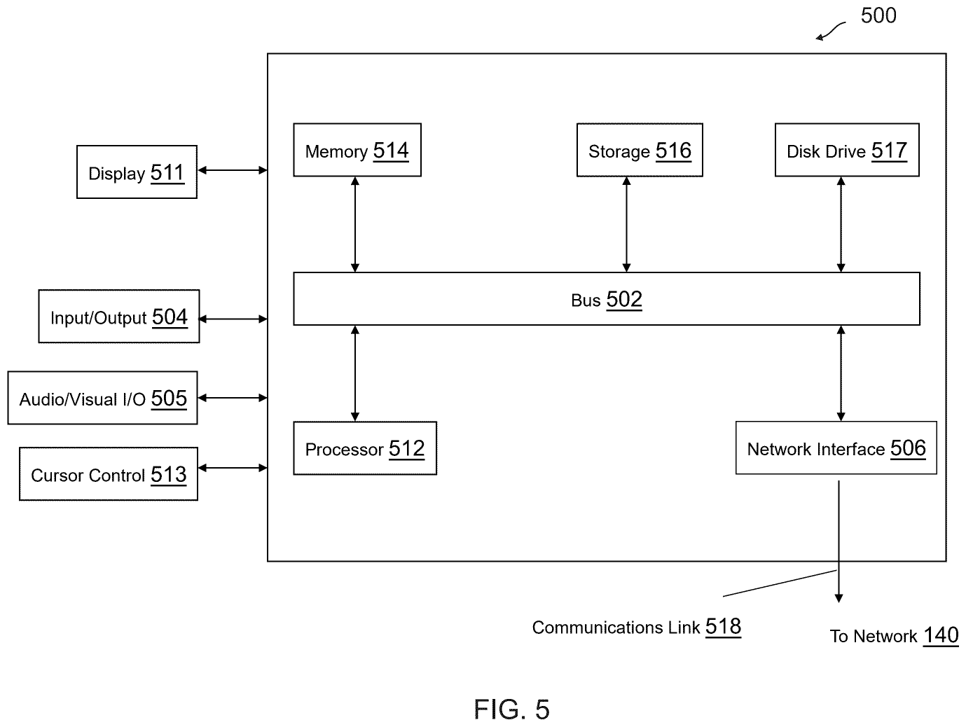

FIG. 5 is a block diagram of a computer system 500 suitable for implementing one or more components in FIG. 1, according to an embodiment. In various embodiments, the communication device may comprise a personal computing device e.g., smart phone, a computing tablet, a personal computer, laptop, a wearable computing device such as glasses or a watch, Bluetooth device, key FOB, badge, etc.) capable of communicating with the network. The service provider may utilize a network computing device (e.g., a network server) capable of communicating with the network. It should be appreciated that each of the devices utilized by users and service providers may be implemented as computer system 500 in a manner as follows.

Computer system 500 includes a bus 502 or other communication mechanism for communicating information data, signals, and information between various components of computer system 500. Components include an input/output (I/O) component 504 that processes a user action, such as selecting keys from a keypad/keyboard, selecting one or more buttons, image, or links, and/or moving one or more images, etc., and sends a corresponding signal to bus 502. I/O component 504 may also include an output component, such as a display 511 and a cursor control 513 (such as a keyboard, keypad, mouse, etc.). An optional audio/visual input/output component 505 may also be included to allow a user to use voice for inputting information by converting audio signals and/or use video to capture still or video images and provide video input. Audio I/O component 505 may allow the user to hear audio and/or view video. A transceiver or network interface 506 transmits and receives signals between computer system 500 and other devices, such as another communication device, service device, or a service provider server via network 140. In one embodiment, the transmission is wireless, although other transmission mediums and methods may also be suitable. One or more processors 512, which can be a micro-controller, digital signal processor (DSP), or other processing component, processes these various signals, such as for display on computer system 500 or transmission to other devices via a communication link 518. Processor(s) 512 may also control transmission of information, such as cookies or IP addresses, to other devices.

Components of computer system 500 also include a system memory component 514 (e.g., RAM), a static storage component 516 (e.g., ROM), and/or a disk drive 517. Computer system 500 performs specific operations by processor(s) 512 and other components by executing one or more sequences of instructions contained in system memory component 514. Logic may be encoded in a computer readable medium, which may refer to any medium that participates in providing instructions to processor(s) 512 for execution. Such a medium may take many forms, including but not limited to, non-volatile media, volatile media, and transmission media. In various embodiments, non-volatile media includes optical or magnetic disks, volatile media includes dynamic memory, such as system memory component 514, and transmission media includes coaxial cables, copper wire, and fiber optics, including wires that comprise bus 502. In one embodiment, the logic is encoded in non-transitory computer readable medium. In one example, transmission media may take the form of acoustic or light waves, such as those generated during radio wave, optical, and infrared data communications.

Some common forms of computer readable media includes, for example, floppy disk, flexible disk, hard disk, magnetic tape, any other magnetic medium, CD-ROM, any other optical medium, punch cards, paper tape, any other physical medium with patterns of holes, RAM, PROM, EEPROM, FLASH-EEPROM, any other memory chip or cartridge, or any other medium from which a computer is adapted to read.

In various embodiments of the present disclosure, execution of instruction sequences to practice the present disclosure may be performed by computer system 500. In various other embodiments of the present disclosure, a plurality of computer systems 500 coupled by communication link 518 to the network (e.g., such as a LAN, WLAN, PSTN, and/or various other wired or wireless networks, including telecommunications, mobile, and cellular phone networks) may perform instruction sequences to practice the present disclosure in coordination with one another.

Where applicable, various embodiments provided by the present disclosure may be implemented using hardware, software, or combinations of hardware and software. Also, where applicable, the various hardware components and/or software components set forth herein may be combined into composite components comprising software, hardware, and/or both without departing from the spirit of the present disclosure. Where applicable, the various hardware components and/or software components set forth herein may be separated into sub-components comprising software, hardware, or both without departing from the scope of the present disclosure. In addition, where applicable, it is contemplated that software components may be implemented as hardware components and vice-versa.

Software, in accordance with the present disclosure, such as program code and/or data, may be stored on one or more computer readable mediums. It is also contemplated that software identified herein may be implemented using one or more general purpose or specific purpose computers and/or computer systems, networked and/or otherwise. Where applicable, the ordering of various steps described herein may be changed, combined into composite steps, and/or separated into sub-steps to provide features described herein.

The foregoing disclosure is not intended to limit the present disclosure to the precise forms or particular fields of use disclosed. As such, it is contemplated that various alternate embodiments and/or modifications to the present disclosure, whether explicitly described or implied herein, are possible in light of the disclosure. Having thus described embodiments of the present disclosure, persons of ordinary skill in the art will recognize that changes may be made in form and detail without departing from the scope of the present disclosure. Thus, the present disclosure is limited only by the claims.

What is claimed is:

1. A method comprising:
receiving a request for an unlearning of a content from a machine learning (ML) model trained using training data including the content, wherein the unlearning reconfigures the ML model to be trained using the training data independent of the content;
performing a content detection check of the ML model for the content based on at least one of the training data, an output by the ML model, or a source code file for the ML model;
mapping, based on the content detection check, the content to relevant concepts learned by the ML model from the content in a vector space associated with a plurality of vectors corresponding to the relevant concepts and the content;
identifying, from a graph representation of at least a portion of the ML model, one or more nodes of the ML model associated with the content based on the relevant concepts mapped to the content; and
performing a selective parameter dampening of the one or more nodes.

2. The method of claim 1, wherein, prior to the performing the content detection check, the method further comprises:
verifying a requestor of the request based on a requestor identifier and a verification token received with the request, wherein the verifying includes checking a user behavior associated with the requestor identifier against a user record and authorizing the verification token.

3. The method of claim 2, wherein the verifying the requestor of the request includes performing a contextual verification based on external verification sources and requester privileges.

4. The method of claim 1, wherein the content comprises one of a copyrighted content or a privacy protected content, and wherein the ML model comprises one of a neural network (NN) having one or more neurons corresponding to the one or more nodes that activate based on the relevant concepts learned from the content or a large language model (LLM) that provides responses based on a knowledge base including the content.

5. The method of claim 1, wherein the performing the content detection check comprises:
comparing the output by the ML model to a database of copyrighted content using a content similarity detection operation; and
flagging any matches of the output to the copyrighted content.

6. The method of claim 1, wherein the performing the content detection check comprises:
identifying privacy protected data in the training data;
determining whether the privacy protected data was masked during a training of the ML model; and
determining, when the privacy protected data was unmasked during the training, a contribution of the privacy protected data to the training of the ML model.

7. The method of claim 1, wherein the performing the content detection check comprises:
generating, from the source code file, a credential dependency graph of credentials learned during a training of the ML model; and
determining a score representing whether one of the credentials corresponding to the content is capable of being leaked by the ML model.

8. The method of claim 1, further comprising:
evaluating a performance of the ML model after the performing the selective parameter dampening to a base performance of the ML model prior to the performing the selective parameter dampening, wherein the evaluating includes testing at least one benchmark ML task performed by the ML model.

9. The method of claim 8, further comprising:
generating an unlearning proof of the ML model after the performing the selective parameter dampening based on the evaluating the performance; and
responding to the request with the unlearning proof.

10. A system comprising:
a non-transitory memory; and
one or more hardware processors coupled to the non-transitory memory and configured to execute instructions to cause the system to:
identify a content for a removal from training of a machine learning (ML) model that was previously trained using training data including the content;
detect one or more usages of the content in at least one of the training data, an output by the ML model, or a source code file for the ML model;
determine, based on the one or more usages, a concept learned by the ML model from the content in a vector space;
identify a node activated during an execution of the ML model that is associated with the concept; and
perform a selective parameter dampening of the node.

11. The system of claim 10, wherein the content comprises privacy protected data for a user, and wherein the privacy protected data is further identified using sensitive data detection component and a database storing flagged instances of sensitive user data.

12. The system of claim 10, wherein the removal comprises an unlearning of the content from the ML model, and wherein executing the instructions further causes the system to:
generate a proof of the unlearning based on the selective parameter dampening; and
transmit the proof to a requester of the unlearning of the content.

13. The system of claim 10, wherein, prior to identifying the content, executing the instructions further causes the system to:
verify a requestor of the removal based on a requestor identifier and a verification token received with a request for the removal.

14. The system of claim 10, wherein determining the concept learned by the ML mode from the content comprises:
generating a mapping of a plurality of concepts learning by the ML model, wherein each of the plurality of concepts correspond to one of a term, a phrase, or a context from the training data, and wherein nodes of the mapping correspond to the plurality of concepts and edges of the mapping correspond to associations between the plurality of concepts; and
correlating the content with the concept from the plurality of concepts based on the mapping.

15. The system of claim 14, wherein identifying the node comprises:
generating a knowledge graph of the plurality of concepts in the vector space;
projecting outputs of the ML model in the vector space; and
determining one or more overlaps between the knowledge graph and the outputs, wherein the node is identified based at least on the one or more overlaps.

16. The system of claim 10, wherein performing the selective parameter dampening comprises:
representing the ML model as a graph having a plurality of nodes connected by a plurality of edges, wherein the plurality of nodes correspond to neurons of the ML model and the plurality of edges correspond to synapses of the ML model; and
analyzing one or more activation patterns and one or more weight distributions of the ML model using the graph during the execution of the ML model.

17. The system of claim 16, wherein performing the selective parameter dampening further comprises:
creating a negation vector based on the analyzing and the graph for the selective parameter dampening.

18. The system of claim 10, wherein the content comprises a protected content, and wherein the protected content is further identified using a retrieval engine and a repository of protected contents utilized as a benchmark of identifying the protected content.

19. A non-transitory machine-readable medium having stored thereon machine-readable instructions executable to cause a machine to perform operations comprising:
testing at least one of training data previously used to train a machine learning (ML) model, an output by the ML model, or model weights of the ML model for content associated with one or more uses of data to be removed from training of the ML model or inferencing by the ML model, wherein the training data comprises the data to be removed;
mapping the content to a concept learned by the ML model from the data in a vector space;
determining a node in the vector space that is associated with the concept and is activated during an execution of the ML model; and
perform a selective parameter dampening of the node for the execution of the ML model.

20. The non-transitory machine-readable medium of claim 19, wherein the node is determined in the vector space with a corresponding negation vector that negates the content by dampening at least one of a neuron or a synapse of the ML model associated with the node.
